(19) United States
(12) Patent Application Publication
(10) Pub. No.: US 2015/0027106 A1
(43) Pub. Date: Jan. 29, 2015

(54) CONTROL APPARATUS FOR OPERATING AN INTERNAL COMBUSTION ENGINE

(71) Applicant: GM GLOBAL TECHNOLOGY OPERATIONS LLC, Detroit, MI (US)

(72) Inventors: Andrea DE FILIPPO, Turin (DE); David B. Brown, Brighton, MI (US); Rahul Mital, Rochester Hills, MI (US)

(21) Appl. No.: 14/446,077

(22) Filed: Jul. 29, 2014

(30) Foreign Application Priority Data
Jul. 29, 2013 (GB) 1313482.0

(51) Int. Cl. F02D 41/02; F01N 3/22; F01N 3/08

(52) U.S. Cl. CPC F02D 41/0275; F01N 3/0885; F01N 3/22
USPC 60/274; 60/286

(57) ABSTRACT

A method and control apparatus is disclosed for operating an internal combustion engine equipped with an after-treatment system including a catalyst. The control is configured to: perform a DeNOₓ regeneration event; monitor a parameter (1ᵤₚ) representative of an air-to-fuel ratio upstream of the catalyst and a parameter (1_{down}) representative of an air-to-fuel ratio downstream of the catalyst; and perform a dedicated operating phase of the internal combustion engine to achieve an increase of the NOₓ emissions, if the value of the parameter (1_{down}) representative of an air-to-fuel ratio downstream of the catalyst is lower than the value of the parameter (1ᵤₚ) representative of an air-to-fuel ratio upstream of the catalyst.

### CROSS REFERENCE TO RELATED APPLICATION

This application claims priority to GB Patent Application No. 1313482.0 filed Jul. 29, 2013, which is incorporated herein by reference in its entirety.

### TECHNICAL FIELD

The technical field relates to a control apparatus for operating an internal combustion engine, and more particularly to a control apparatus for operating an internal combustion engine to increase the performance of SCR or SCRF systems.

### BACKGROUND

An internal combustion engine for a motor vehicle generally includes an engine block defining at least one cylinder accommodating a reciprocating piston coupled to rotate a crankshaft. The cylinder is closed by a cylinder head that cooperates with the reciprocating piston to define a combustion chamber. A fuel and air mixture is cyclically disposed in the combustion chamber and ignited, thereby generating hot expanding exhaust gasses that cause the reciprocating movements of the piston. The fuel is injected into each cylinder by a respective fuel injector. The fuel is provided at high pressure to each fuel injector from a fuel rail in fluid communication with a high pressure fuel pump that increase the pressure of the fuel received from a fuel source.

Due to stringent emissions regulation, internal combustion engines are associated with after-treatment systems. An after-treatment system may include one or more after-treatment devices provided in an exhaust system of the internal combustion engine. For example, an after-treatment system may include an oxidation catalyst such as a Diesel Oxidation Catalyst (DOC), namely a device that utilizes a chemical process in order to break down pollutants from diesel engines in the exhaust stream, turning them into less harmful components. DOCs have normally a honeycomb shaped configuration coated in a catalyst designed to trigger a chemical reaction to reduce particulate matter. DOCs contain palladium and platinum or Ceria (cerium oxide), which serve as catalysts to oxidize hydrocarbons and carbon monoxide into carbon dioxide and water. An alternative to DOC may be a Three Way Catalyst (TWC).

In a further alternative, Lean NOx Trap (LNT) may be used. A LNT is a device that traps nitrogen oxides (NOₓ) contained in the exhaust gas and is generally located in the exhaust pipe upstream of a Diesel Particulate Filter (DPF). More specifically, a LNT is a catalytic device containing catalysts, such as Rhodium, Pt and Pd, and adsorbents, such as barium based elements, which provide active sites suitable for binding the nitrogen oxides (NOₓ) contained in the exhaust gas, in order to trap them within the device itself

After-treatment systems may also include a DPF (Diesel Particulate Filter) which filters the PM (Particulate Matter) and a SCR device (Selective Catalytic Reduction) which is a catalytic device in which the nitrogen oxides (NOₓ) contained in the exhaust gas are reduced into diatomic nitrogen (N₂) and water (H₂O), with the aid of a gaseous reducing agent, typically ammonia (NH₃) that can be obtained by urea (CH₄N₂O) thermo-hydrolysis and that is absorbed inside catalyst. Typically, urea is contained in a dedicated tank and is injected in the exhaust line and mixed with the exhaust gas upstream the SCR. Other fluids can be used in a SCR in lieu of urea and are generally referred to as Diesel Exhaust Fluids (DEF). An alternative to the SCR is a SCRF (SCR on Filter), namely a device that combines in a single unit an SCR and a DPF (Diesel Particulate Filter), which filters the PM (Particulate Matter).

Generally speaking, internal combustion engines are currently operated with multi-injection patterns, namely for each engine cycle, a train of injection pulses is performed, starting from a pilot injection pulse and following a main injection pulse, eventually terminating with after and post injections. In particular, fuel after-injections in multi-injection patterns are fuel injections in a cylinder of the engine that occur after the Top Dead Center (TDC) of the piston. Part of the fuel injected by means of after-injections burns in the exhaust line raising the temperature thereof. Fuel injections in a multi-injection pattern can be employed for several different tasks, and in particular may be used to perform DeNOₓ. regeneration events when needed.

DeNOₓ regeneration events are operated by switching the engine from a lean burn operation to a rich operation, such regeneration events being provided to release and reduce the trapped nitrogen oxides (NOₓ) in a catalyst, such as the LNT. Since an SCR or an SCRF must be used in conjunction with ammonia as a reducing agent, whereby ammonia is chemically derived from urea, problems may arise when urea tank level is low. The operation of the SCR or of the SCRF is therefore also dependent on the range of on-board urea supply.

Moreover, in certain situations, urea injection is not allowed because of environmental conditions. In particular, during specific driving conditions, for example at low temperature upstream the SCR or SCRF, the urea injection is not allowed because it does not provide ammonia in gas phase.

Moreover, depending on the actual conditions of the SCR or SCRF, it might be possible that the Electronic Control Unit that manages the engine requests an extra ammonia quantity. Also, depending on the specific driving conditions, it might be possible that the controller requests ammonia as soon as possible.

### SUMMARY

A strategy for operating an internal combustion engine management of the combustion mode is disclosed in order to favor the production of ammonia and increase the performance of an SCR or an SCRF system downstream of the engine by means of a simple, rational and inexpensive solution.

An embodiment of the disclosure provides for a control apparatus for operating an internal combustion engine, the engine being equipped with an after-treatment system including a catalyst, the control apparatus including an Electronic Control Unit (ECU) configured to: perform a DeNOₓ regeneration event; monitor a parameter representative of an air-to-fuel ratio upstream of the catalyst and a parameter representative of an air-to-fuel ratio downstream of the catalyst; and perform a dedicated operating phase of the internal combustion engine to achieve an increase of the NOₓ emissions, if the value of the parameter representative of an air-to-fuel ratio downstream of the catalyst is lower than the value of the parameter representative of an air-to-fuel ratio upstream of the catalyst.

An advantage of this embodiment is that increasing NOx engine-out emissions during rich combustion events and then converting this NOx to NH3 over a catalyst in a reducing environment obtain an increased NH3 production. Another advantage of this embodiment is that it could be used either to reduce the urea consumption or to keep the same performances of the SCR or the SCRF before urea refill. Furthermore a continuous use of this strategy might help to reduce the final urea tank size. Another advantage of this embodiment is that it allows to enhance or substitute the role of the urea injector in conditions where urea injection is not allowed because, it does not provide ammonia in gas phase, such as at low temperature upstream the SCR or SCRF. A further advantage of this embodiment is that it allows to support an extra ammonia quantity request by the Electronic Control Unit without any penalties in terms of urea consumption. Finally, the above embodiment is able to support urgent ammonia requests because the duration of the increase the NOₓ emissions phase can be as short as needed.

According to an embodiment of the present disclosure, the apparatus is configured to increase the NOₓ emissions of the internal combustion engine by increasing an air quantity drawn into the engine. An advantage of this embodiment is that it allows a temporary increase the NOₓ emissions of the internal combustion engine, for example by acting on the throttle body provided to regulate the flow of air into the engine intake manifold.

According to another embodiment of the present disclosure, the apparatus is configured to increase the NOₓ emissions of the internal combustion engine by decreasing EGR recirculation mass flow. An advantage of this embodiment is that it allows a temporary increase the NOₓ emissions of the internal combustion engine, for example operating on the EGR valve position.

According to still another embodiment to the present disclosure, the apparatus is configured to increase the NOₓ emissions of the internal combustion engine by employing a map that correlates the NOₓ emissions to the air quantity drawn into the engine and the EGR recirculation mass flow. An advantage of this embodiment is that it allows to perform an increase of the NOₓ emissions in order to favor the production of ammonia in the exhaust system of the engine by taking advantage from the computational capabilities of the Electronic Control Unit (ECU) of the vehicle.

According to still another embodiment of the present disclosure, the apparatus is configured to increase the NOₓ emissions for a predefined interval of time. An advantage of this embodiment is that the determination of the length of the phase of increasing the NO emissions can be performed easily by means of predefined time length.

According to another embodiment of the present disclosure, the apparatus is configured to end the dedicated operating phase when a desired ammonia mass is reached. An advantage of this embodiment is that the determination of the end of the phase of increased NOₓ emissions can be performed by a predictive mathematical model or a look-up table based on the engine speed and load or by a measure of a NH₃ mass value by an ammonia sensor.

Another embodiment of the present disclosure provides a method of operating an internal combustion engine, the engine being equipped with an after-treatment system including a catalyst, the method including the steps of: perform a DeNOₓ regeneration event; monitoring a parameter representative of an air-to-fuel ratio upstream of the catalyst and a parameter representative of an air-to-fuel ratio downstream of the catalyst; and perform a dedicated operating phase of the internal combustion engine to achieve an increase of the NOₓ emissions, if the value of the parameter representative of an air-to-fuel ratio downstream of the catalyst is lower than the value of the parameter representative of an air-to-fuel ratio upstream of the catalyst.

An advantage of this embodiment is that it could be used either to reduce the urea consumption or to keep the same performances of the SCR or the SCRF before urea refill. Furthermore a continuous use of this strategy might help to reduce the final urea tank size. Another advantage of this embodiment is that it allows to enhance or substitute the role of the urea injector in conditions where urea injection is not allowed because does not provide ammonia in gas phase, such as at low temperature upstream the SCR or SCRF. A further advantage of this embodiment is that this strategy supports an extra ammonia quantity request by the Electronic Control Unit without any penalties in terms of urea consumption. Finally, the strategy may support urgent ammonia requests because the duration of the increase the NOₓ emissions phase can be as short as needed.

According to another aspect the present disclosure, the method includes the step of increasing the NOₓ emissions of the internal combustion engine by increasing an air quantity drawn into the engine. An advantage of this aspect, is that it allows a temporary increase the NOₓ emissions of the internal combustion engine for example by acting on the throttle body provided to regulate the flow of air into the engine intake manifold.

According to another aspect of the present disclosure, the method includes the step of increasing of the NOₓ emissions of the internal combustion engine by decreasing EGR recirculation mass flow. An advantage of this aspect, is that it allows a temporary increase the NOₓ emissions of the internal combustion engine for example operating on the EGR valve position.

According to still another aspect of the present disclosure, the method includes the step of increasing the NOₓ emissions of the internal combustion engine by employing a map that correlates the NOₓ emissions to the air quantity drawn into the engine and the EGR recirculation mass flow. An advantage of this aspect is that it allows to perform an increase of the NOₓ emissions in order to favor the production of ammonia in the exhaust system of the engine by taking advantage from the computational capabilities of the Electronic Control Unit (ECU) of the vehicle.

According to another aspect of the present disclosure, the method includes a step of increasing the NOₓ emissions for a predefined interval of time. An advantage of this aspect is that the determination of the length of the phase of increased NOₓ emissions can be performed easily by means of predefined time length.

According to another aspect of the present disclosure, the method includes a step of ending the dedicated operating phase when a desired ammonia mass is reached. An advantage of this embodiment is that the determination of the end of the phase of increased of the NOₓ emissions can be performed by a predictive mathematical model or a look-up table based on the engine speed and load or by a measure of a NH₃ mass value by an ammonia sensor.

Another embodiment of the present disclosure provides an apparatus for operating an internal combustion engine, the engine being equipped with an after-treatment system including a catalyst, the apparatus including: means for performing a DeNOₓ regeneration event; means for monitoring a parameter representative of an air-to-fuel ratio upstream of the catalyst and a parameter representative of an air-to-fuel ratio downstream of the catalyst; and means for performing a dedicated operating phase of the internal combustion engine to achieve an increase of the NOₓ emissions, if the value of the parameter representative of an air-to-fuel ratio downstream of the catalyst is lower than the value of the parameter representative of an air-to-fuel ratio upstream of the catalyst.

An advantage of this embodiment is that, in this way, increasing NOx engine-out emissions during rich combustion events and then converting this NOx to NH3 over a catalyst in a reducing environment obtain an increased NH3 production. Another advantage of this embodiment is that it could be used either to reduce the urea consumption or to keep the same performances of the SCR or the SCRF before urea refill. Furthermore a continuous use of this strategy might help to reduce the final urea tank size. Another advantage of this embodiment is that it allows to enhance or substitute the role of the urea injector in conditions where urea injection is not allowed because does not provide ammonia in gas phase, such as at low temperature upstream the SCR or SCRF. A further advantage of this embodiment is that it allows to support an extra ammonia quantity request by the Electronic Control Unit without any penalties in terms of urea consumption. Finally, the above embodiment is able to support urgent ammonia requests because the duration of the increase the NOₓ emissions phase can be as short as needed.

According to an embodiment of the present disclosure, the apparatus is configured to increase the NOₓ emissions of the internal combustion engine by increasing an air quantity drawn into the engine. An advantage of this embodiment is that it allows a temporary increase the NOₓ emissions of the internal combustion engine for example by acting on the throttle body provided to regulate the flow of air into the engine intake manifold.

According to another embodiment to the present disclosure, the apparatus is configured to increase the NOₓ emissions of the internal combustion engine by decreasing EGR recirculation mass flow. An advantage of this embodiment is that it allows a temporary increase the NOₓ emissions of the internal combustion engine, for example operating on the EGR valve position.

According to still another embodiment to the present disclosure, the apparatus is configured to increase the NOₓ emissions of the internal combustion engine by employing a map that correlates the NOₓ emissions to the air quantity drawn into the engine and the EGR recirculation mass flow. An advantage of this embodiment is that it allows to perform an increase of the NOₓ emissions in order to favor the production of ammonia in the exhaust system of the engine by taking advantage from the computational capabilities of the Electronic Control Unit (ECU) of the vehicle.

According to still another embodiment of the present disclosure, the apparatus is configured to increase the NOₓ emissions for a predefined interval of time. An advantage of this embodiment is that the determination of the length of the phase of increased of the NO emissions can be performed easily by means of predefined time length.

According to another embodiment of the present disclosure, the apparatus is configured to end the dedicated operating phase when a desired ammonia mass is reached. An advantage of this embodiment is that the determination of the end of the phase of increased of the NOₓ emissions can be performed by a predictive mathematical model or a look-up table based on the engine speed and load or by a measure of a NH₃ mass value by an ammonia sensor.

Still another embodiment of the present disclosure provides an automotive system including an internal combustion engine managed by an engine Electronic Control Unit, the engine being equipped with an after-treatment system including a catalyst, the Electronic Control Unit being configured to: perform a DeNOₓ regeneration event; monitor a parameter representative of an air-to-fuel ratio upstream of the catalyst and a parameter representative of an air-to-fuel ratio downstream of the catalyst; and perform a dedicated operating phase of the internal combustion engine to achieve an increase of the NOₓ emissions, if the value of the parameter representative of an air-to-fuel ratio downstream of the catalyst is lower than the value of the parameter representative of an air-to-fuel ratio upstream of the catalyst.

The method according to one of its aspects can be carried out with the help of a computer program including a program-code for carrying out all the steps of the method described above, and in the form of computer program product including the computer program. The computer program product can be embodied as a control apparatus for an internal combustion engine, including an Electronic Control Unit (ECU), a data carrier associated to the ECU, and the computer program stored in a data carrier, so that the control apparatus defines the embodiments described in the same way as the method. In this case, when the control apparatus executes the computer program all the steps of the method described above are carried out.

A still further aspect of the disclosure provides an internal combustion engine specially arranged for carrying out the method claimed.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a cross-section of an internal combustion engine belonging to the automotive system of FIG. 1;

FIG. 3 is a schematic representation of an after-treatment system to which the various embodiments of the method of operating an internal combustion engine can be applied;

FIG. 4 is a schematic representation of an alternative embodiment of an after-treatment system;

FIG. 5 represents a graph of a lambda breakthrough; and

FIG. 6 is a flowchart representing an embodiment of the method of the present disclosure.

### DETAILED DESCRIPTION OF THE DRAWINGS

The following detailed description is merely exemplary in nature and is not intended to limit the present disclosure or the application and uses of the present disclosure. Furthermore, there is no intention to be bound by any theory presented in the preceding background or the following detailed description. Preferred embodiments will now be described with reference to the enclosed drawings.

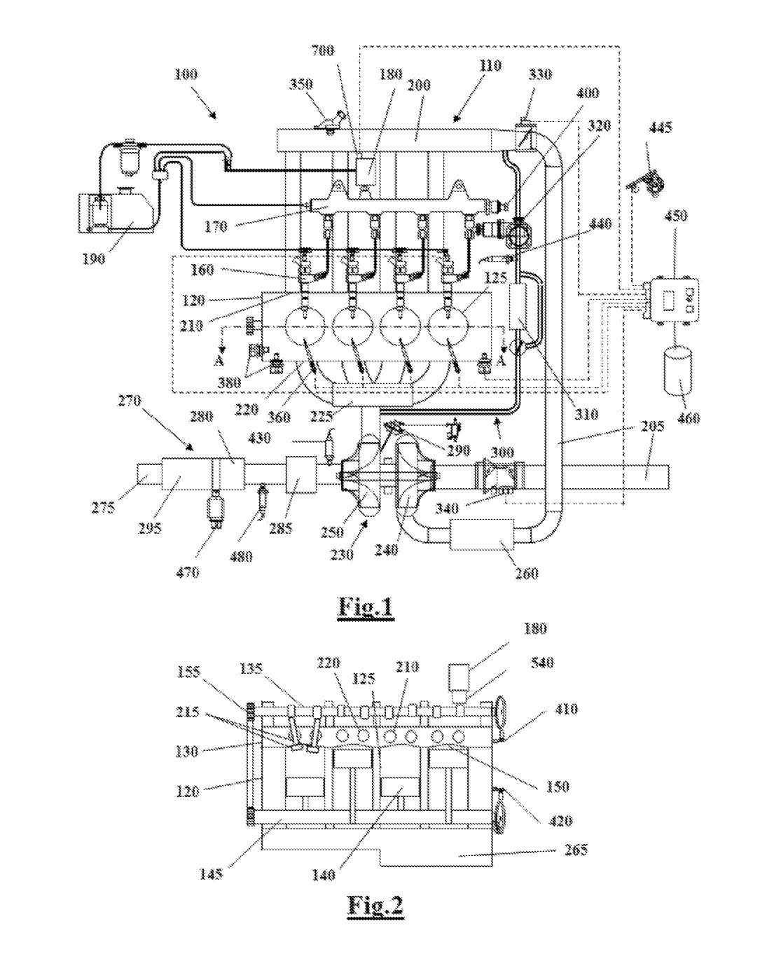

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high-pressure fuel pump 180 that increase the pressure of the fuel received a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust after-treatment devices. The after-treatment devices may be any device configured to change the composition of the exhaust gases. Some examples of after-treatment devices include, but are not limited to, catalytic converters (two and three way), such as a Diesel Oxidation Catalyst (DOC) 285, lean NOx traps 287, hydrocarbon adsorbers, selective catalytic reduction (SCR) systems, SCRF (SCR on Filter) 280, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, an exhaust pressure sensor and an exhaust temperature sensor 470, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system, or data carrier 460, and an interface bus. The CPU is configured to execute instructions stored as a program in the memory system, and send and receive signals to/from the interface bus. The memory system may include various storage types including optical storage, magnetic storage, solid-state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

The program stored in the memory system is transmitted from outside via a cable or in a wireless fashion. Outside the automotive system 100 it is normally visible as a computer program product, which is also called computer readable medium or machine readable medium in the art, and which should be understood to be a computer program code residing on a carrier, said carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing said computer program code is impressed on the transitory electromagnetic signal. Such signals are e.g. made use of when transmitting computer program code in a wireless fashion via a WiFi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an onboard computer, or any processing module that might be deployed in the vehicle.

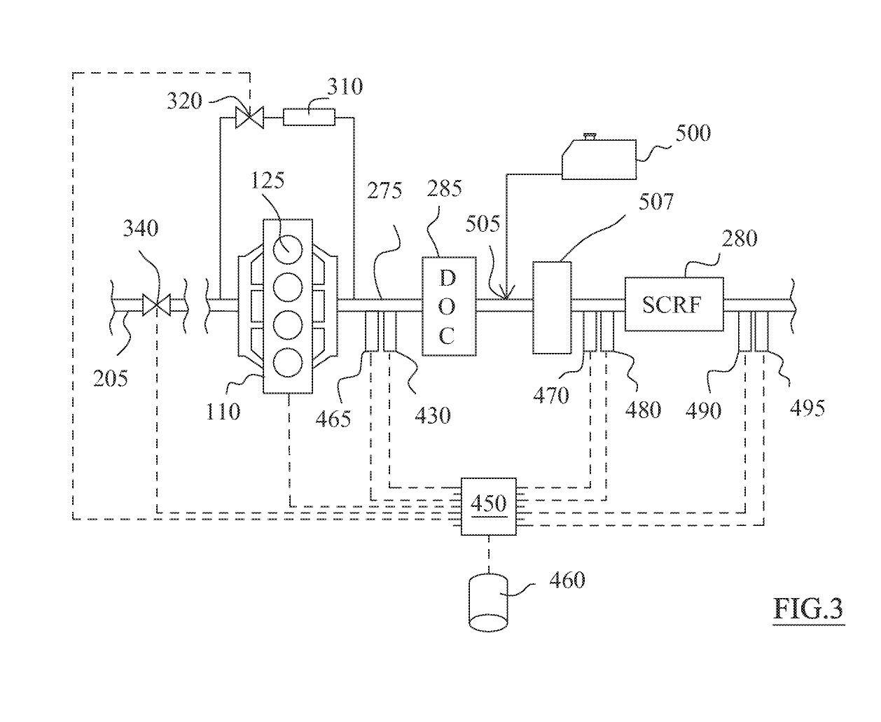

FIG. 3 is a schematic representation of an after-treatment system to which the various embodiments of the method of operating an internal combustion engine can be applied. In FIG. 3, the exhaust pipe 275 of the engine 110 is equipped with a Diesel Oxidation Catalyst (DOC) 285 and an SCRF system 280, namely an SCR on Filter. Upstream of the SCRF 280, an urea injection system is provided, the urea injection system including an urea tank 500 and an urea injector 505. Urea is injected in a point upstream of an urea mixer 507 that mixes the urea injected with the exhaust gas stream.

An air-to-fuel ratio sensor (or lambda sensor) 430 and an exhaust temperature sensor 465 are provided upstream of the DOC 285. Furthermore, an air-to-fuel ratio sensor 480 and an exhaust temperature sensor 470 are provided downstream of the DOC 285. Data from the upstream air-to-fuel ratio sensor 430, namely a parameter 1ᵤₚ representative of an air-to-fuel ratio upstream of the DOC catalyst 285, and data from the downstream air-to-fuel ratio sensor 480, namely a parameter 1_{down} representative of an air-to-fuel ratio downstream of the DOC catalyst 285 may be monitored simultaneously. By virtue of this double monitoring, a condition generally known as lambda breakthrough, namely the point when the air-to-fuel ratio 1_{down} of the downstream exhaust is less than the air-to-fuel ratio 1ᵤₚ of the exhaust upstream from the catalyst, can be detected. Finally, downstream of the SCRF 280, a NOₓ sensor 490 and a Particulate Matter (PM) sensor 495 are provided.

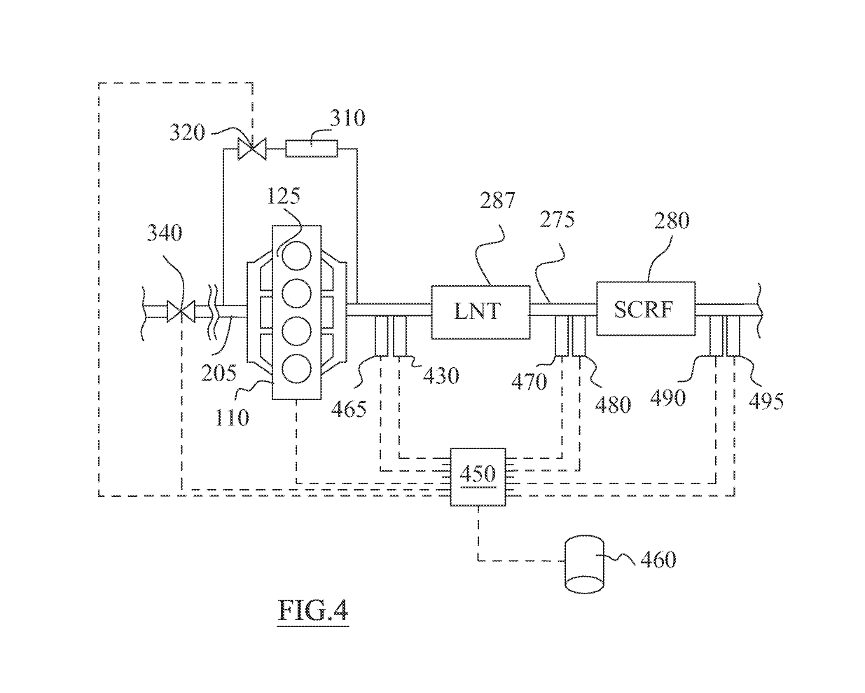

FIG. 4 is a schematic representation of an alternative embodiment of an after-treatment system. In this case, the catalyst used is an LNT 287, which is placed upstream of the SCRF 280. An air-to-fuel ratio sensor 430 and an exhaust temperature sensor 465 are provided upstream of the LNT 287 and an air-to-fuel ratio sensor 480 and an exhaust temperature sensor 470 are provided downstream of the LNT 287. The air-to-fuel ratio sensors 430,480 can be used, also in this case, to determine a lambda breakthrough condition in the same fashion as explained above. Also in this case, downstream of the SCRF 280, a NOₓ sensor 490 and Particulate Matter (PM) sensor 495 are provided.

As an alternative, in the various embodiment of the present disclosure, the SCRF 280 can be substituted with an SCR and a Diesel Particulate Filter (DPF).

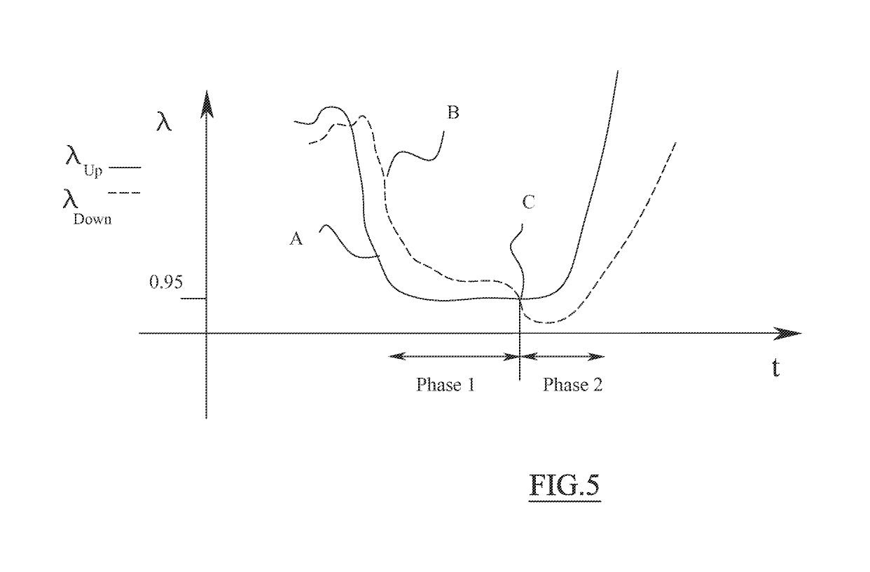

FIG. 5 is a graph representing an example of monitoring an upstream air-to-fuel ratio (curve A) and a downstream air-to-fuel ratio (curve B). Downstream air-to-fuel ratio becomes lower than upstream air-to-fuel ratio at a lambda breakthrough point C.

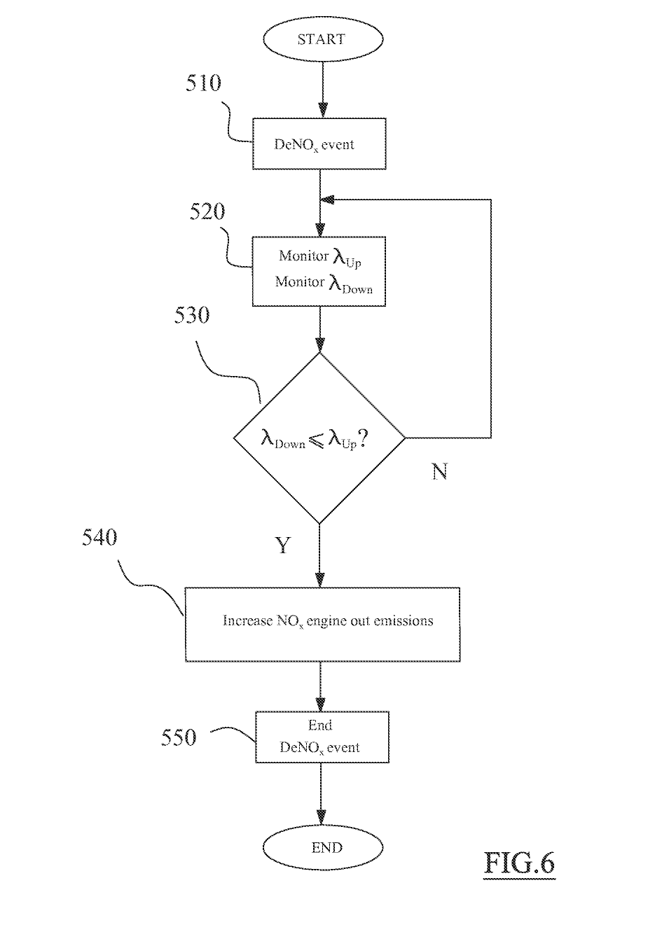

FIG. 6 is a flowchart representing an embodiment of the method of the present disclosure.

In a first step of the method, a DeNOₓ regeneration event is performed (block 510). That means that the ECU 450 determines, according to known procedures, that a catalyst DeNOₓ regeneration is needed and operates in such a way to switch the engine 110 from a lean burn operation to a rich operation. The catalyst subjected to the DeNOₓ regeneration may be a DOC catalyst 285 or a LNT catalyst 287 depending on the various embodiments of the present disclosure.

This operation may be done by creating a fuel rich environment by injected additional quantities of fuel in the cylinders 125 for example by means of after injections, namely fuel injections that occur after the Top Dead Center and burn partially or totally in the exhaust pipe 275. Appropriate engine maps stored in the data carrier 460 associated with the ECU 450 can be used to generate these after injections.

During the performance of a DeNOₓ regeneration event a parameter 1ᵤₚ representative of an air-to-fuel ratio upstream of the catalyst and a parameter 1_{down} representative of an air-to-fuel ratio downstream of the catalyst are monitored (block 520). A check is made in order to verify if the air-to-fuel ratio 1_{down} downstream of the catalyst is lower than the air-to-fuel ratio 6 upstream of the catalyst (block 530). If the check is negative, the DeNOₓ regeneration event is continued employing standard and known management of the engine parameters, such as intake air and EGR recirculation parameters (Phase 1 in FIG. 5). More specifically, this standard air management may be performed by employing a standard map memorized in the data carrier 460 associated to the ECU 450, the standard map correlating intake air and EGR recirculation values to NOₓ engine-out emissions. The ECU is therefore configured to generate signals that act upon these variables, for example by acting upon the position the throttle body 330 for the intake air and upon the EGR valve 320 for the EGR recirculation by using the standard map.

According to the various embodiments of the present disclosure, a modified map that correlates the NOₓ emissions to intake air and EGR recirculation values is also employed. The modified map can be determined through calibration by means of an experimental activity and memorized in the data carrier 460 associated to the ECU 450, the modified map including higher intake air flow values and lower EGR recirculation mass flow values with respect to the standard map.

If the check is positive, namely if the value of the air-to-fuel ratio downstream of the catalyst 1_{down} is lower than the value of the air-to-fuel ratio upstream of the catalyst 1ᵤₚ, or, in other words, a lambda breakthrough has occurred, the DeNOₓ regeneration event is continued, but the NOₓ emissions of the internal combustion engine 110 are increased (block 540; Phase 2 in FIG. 5).

To perform a dedicated operating phase of the internal combustion engine 110 to achieve an increase of the NOₓ emissions, the ECU 450 switches from the standard map to the modified map for both the intake air flow and the EGR recirculation, specifically calibrated to have higher NOₓ engine-out emissions during this phase. The NOₓ emissions of the internal combustion engine 110 are increased by increasing an air quantity drawn into the engine 110, for example operating on the position of the throttle body 330. Moreover, the NOₓ emissions of the internal combustion engine 110 may be increased by decreasing EGR mass flow recirculation, for example operating on the EGR valve 320 position.

Since in this phase the O₂ level and the NOₓ stored should be at a very low level (almost 0), the higher NOₓ emitted in this phase will react with the HC/CO/H2 generated by the fuel injected to reach a lambda target (for example 0.95), producing in this way the extra-desired ammonia (NH₃). This higher NOₓ engine-out emissions can be terminated following different possible end criteria. For example a time length can be predetermined by means of a calibration activity and a counter can be started at the beginning of this phase and the phase ended when the counter reaches the time length value. Alternatively, an higher NOₓ engine-out emissions phase end criterion can be set by means of a desired NH₃ mass value for use on the SCR or the SCRF.

In a first method, the ECU is configure to estimate the NH₃ mass value by a predictive mathematical model or a look-up table based on the engine speed and load. Alternatively, the NH₃ mass value can be measured by an ammonia sensor (not represented for simplicity) and the higher NOₓ engine-out emissions phase be ended when the measured NH₃ mass value reaches a desired value. The various embodiments of the present disclosure may apply to a general after-treatment layout having at least an oxidation catalyst or a Lean NOX Trap and a SCR or a SCRF system.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-11. (canceled)

12. A control apparatus for operating an internal combustion engine equipped with an after-treatment system having a catalyst, the control apparatus comprising:
an Electronic Control Unit (ECU) configured to:
perform a DeNOₓ regeneration event;
monitor a parameter (1ᵤₚ)representative of an air-to-fuel ratio upstream of the catalyst, and a parameter (1_{down}) representative of an air-to-fuel ratio downstream of the catalyst; and
perform a dedicated operating phase of the internal combustion engine to achieve an increase of the NOₓ emissions, if the value of the parameter (1_{down}) representative of an air-to-fuel ratio downstream of the catalyst is lower than the value of the parameter (1ᵤₚ)representative of an air-to-fuel ratio upstream of the catalyst.

13. The control apparatus according to claim 12, wherein the Electronic Control Unit is configured to increase of the NOₓ emissions of the internal combustion engine by increasing an air quantity drawn into the engine.

14. The control apparatus according to claim 11, wherein the Electronic Control Unit is configured to increase of the NOₓ emissions of the internal combustion engine by decreasing EGR recirculation mass flow.

15. The control apparatus according to claim 11, wherein the Electronic Control Unit is configured to increase the NOₓ emissions of the internal combustion engine by employing a map that correlates the NOₓ emissions to the air quantity drawn into the engine and the EGR recirculation mass flow.

16. The control apparatus according to claim 11, wherein the Electronic Control Unit is configured to increase the NOₓ emissions for a predefined interval of time.

17. The control apparatus according to claim 11, wherein the Electronic Control Unit is configured to end the dedicated operating phase when a desired ammonia mass is reached.

18. A method of operating an internal combustion engine equipped with an after-treatment system having a catalyst, the method comprising:
performing a DeNOₓ regeneration event;
monitoring a parameter (1ᵤₚ) representative of an air-to-fuel ratio upstream of the catalyst and a parameter (1_{down}) representative of an air-to-fuel ratio downstream of the catalyst;
performing a dedicated operating phase of the internal combustion engine to achieve an increase of the NOₓ emissions, if the value of the parameter (1_{down}) representative of an air-to-fuel ratio downstream of the catalyst is lower than the value of the parameter (1ᵤₚ) representative of an air-to-fuel ratio upstream of the catalyst.

19. The method according to claim 18 further comprising increasing an air quantity drawn into the engine to increase the NOₓ emissions of the internal combustion engine.

20. The method according to claim 18 further comprising decreasing EGR recirculation mass flow to increase the NOₓ emissions of the internal combustion engine.

21. The method according to claim 18 further comprising employing a map that correlates the NOₓ emissions to the air quantity drawn into the engine and the EGR recirculation mass flow to increase the NOₓ emissions of the internal combustion engine.

22. The method according to claim 18 wherein the NOₓ emissions is increased for a predefined interval of time.

23. The method according to claim 18 wherein the dedicated operating phase ends when a desired ammonia mass is reached.

24. A non-transitory computer readable medium comprising a computer program product for performing the method according to claim 18.

25. An automotive system comprising:
an internal combustion engine equipped with an after-treatment system having a catalyst; and
an electronic control unit managing the internal combustion engine, the electronic control unit configured to:
perform a DeNOₓ regeneration event;
monitor a parameter (1ᵤₚ)representative of an air-to-fuel ratio upstream of the catalyst and a parameter (1_{down}) representative of an air-to-fuel ratio downstream of the catalyst; and
perform a dedicated operating phase of the internal combustion engine to achieve an increase of the NOₓ emissions, if the value of the parameter (1_{down}) representative of an air-to-fuel ratio downstream of the catalyst is lower than the value of the parameter (1ᵤₚ)representative of an air-to-fuel ratio upstream of the catalyst.

26. The automotive system according to claim 25 wherein the after-treatment device is located downstream of the catalyst and selected from the group consisting of an SCR and an SCRF.
